(19) United States
(12) Patent Application Publication
(10) Pub. No.: US 2020/0263709 A1
(43) Pub. Date: Aug. 20, 2020

(54) Reset Relief Valve with Dampening Reservoir

(71) Applicant: Petro Control Systems, Inc., Houston, TX (US)

(72) Inventor: Gerard S Lazzara, Houston, TX (US)

(73) Assignee: Petro Control Systems, Inc., Houston, TX (US)

(21) Appl. No.: 16/789,618

(22) Filed: Feb. 13, 2020

Related U.S. Application Data
(60) Provisional application No. 62/805,424, filed on Feb. 14, 2019.

(51) Int. Cl. F15B 15/22; F15B 15/14

(52) U.S. Cl. CPC F15B 15/222; F15B 15/224; F15B 15/22; F15B 15/1414

(57) ABSTRACT

A reset relief valve with dampening reservoir having a piston disposed in fluid flow-blocking relationship between an inlet port and the outlet port of the body and a second position at which the piston is removed from the fluid flow-blocking position, the piston partially defines an enclosed first chamber and at least one flow passageway extending between the chamber and a reservoir chamber mounted on the body for controlled flow of hydraulic fluid to dampen the movement of the piston upon activation, The reservoir has a pressure monitor to measure fluid pressure in the system, a sight glass and index to view and measure the hydraulic fluid and a tubular flow passageway.

### CROSS-REFERENCE TO RELATED APPLICATION

This application claims the benefit of U.S. Provisional Patent Application Ser. No. 62/805,424 filed on 14 Feb. 2019 entitled “RESET RELIEF VALVE WITH DAMPENING RESERVOIR” which is incorporated herein by reference.

### STATEMENT REGARDING FEDERALLY SPONSORED RESEARCH OR DEVELOPMENT

Not Applicable

### DESCRIPTION OF ATTACHED APPENDIX

Not Applicable

### FIELD OF THE INVENTION

This invention relates to the field of valves, and more particularly to a reset valve with a dampening reservoir and sight glass.

### BACKGROUND OF THE INVENTION

A pressure relief valve having a body with an inlet port, an enclosed sleeve defining an upper chamber and a lower chamber enclosed by the body of a piston; the piston is disposed in the body and moveable between a first position at which the piston is disposed in fluid flow-blocking relationship between the inlet port and the outlet port of the body and second position at which the piston is removed from the fluid flow-blocking position. The piston has a hollow stem with an opening for fluid passage to a side port that when transitioned to open position allows a fluid to pass from inlet through piston to side port exiting outlet.

The valve has a first seal member disposed in the body in sealing relationship with the piston's upper seal area above enclosed flow path exhaust port and outlet a second seal in piston for first chamber and opening in the piston to permit fluid flow upon activation of the valve.

The piston displaces a void above the piston filled with a fluid, preferably an oil, that is alternatively stored in a reservoir that receives the fluid upon activation of the valve. The reservoir provides a location for the oil to flow upon activation and dampens the impact of the piston upon activation. Further, the reservoir has an integral sight glass that allows the operator to see the level of oil available to the upper chamber and is operably connected to a gauge that shows instantaneous pressure readings upon activation of the valve.

### SUMMARY OF THE INVENTION

A primary advantage of the invention is to provide a dampening reservoir for a reset relief valve.

Another advantage of the invention is to provide an active pressure monitor for a dampening reservoir for a reset relief valve.

Yet another advantage of the invention is to provide a sight glass for an operator to visually monitor the level of oil in the dampening reservoir.

In accordance with a preferred embodiment of the invention there is shown a reset relief valve with dampening reservoir comprising a body having an inlet port, an outlet port, and an interior wall partially defining an enclosed chamber, a piston disposed in the body and moveable between a first position at which, the piston is disposed in fluid flow-blocking relationship between the inlet port and the outlet port of the body and a second position at which the piston is removed from the fluid flow-blocking position, the piston having a head which partially defines an enclosed first chamber and at least one flow passageway extending between the chamber in the body and a reservoir chamber mounted on the body for controlled flow of hydraulic fluid to dampen the movement of the piston upon activation, a bonnet attached to the body; and a stem bushing disposed in the bonnet in spaced relationship with the head of the piston, the stem bushing having a surface defining another portion of the first chamber and an internal bore in which the stem is slidably supported.

In accordance with another preferred embodiment of the invention there is shown a reset relief valve with dampening reservoir having a body having an inlet port, an outlet port, and an interior wall partially defining an enclosed chamber, a piston disposed in the body and moveable between a first position at which the piston is disposed in fluid flow-blocking relationship between the inlet port and the outlet port of the body and a second position at which the piston is removed from the fluid flow-blocking position, the piston having a head which partially defines an enclosed first chamber and at least one flow passageway extending between the chamber in the body and a reservoir chamber mounted on the body in fluid communication with the first chamber, a bonnet attached to the body, and a stem bushing disposed in the bonnet in spaced relationship with the head of the piston, the stem bushing having a surface defining another portion of the first chamber and an internal bore in which the stem is slidably supported.

In accordance with another preferred embodiment of the invention there is shown a reset relief valve with dampening reservoir having a body having an inlet port, an outlet port, and an interior wall partially defining an enclosed chamber, a piston disposed in the body and moveable between a first position at which the piston is disposed in fluid flow-blocking relationship between the inlet port and the outlet port of the body and a second position at which the piston is removed from the fluid flow-blocking position, the piston having a head which partially defines an enclosed first chamber and a tubular passageway extending between the chamber in the body and a reservoir body having a chamber mounted in fluid communication with the first chamber, a bonnet attached to the body, and a stem bushing disposed in the bonnet in spaced relationship with the head of the piston, the stem bushing having a surface defining another portion of the first chamber and an internal bore in which the stem is slidably supported.

Other objects and advantages of the present invention will become apparent from the following descriptions, taken in connection with the accompanying drawings, where, by way of illustration and example, preferred embodiments of the invention are disclosed.

The drawings constitute a part of this disclosure and include exemplary embodiments to the invention, which may be embodied in various forms. It is to be understood that in some instances various aspects of the invention may be shown exaggerated or enlarged to facilitate an understanding of the invention.

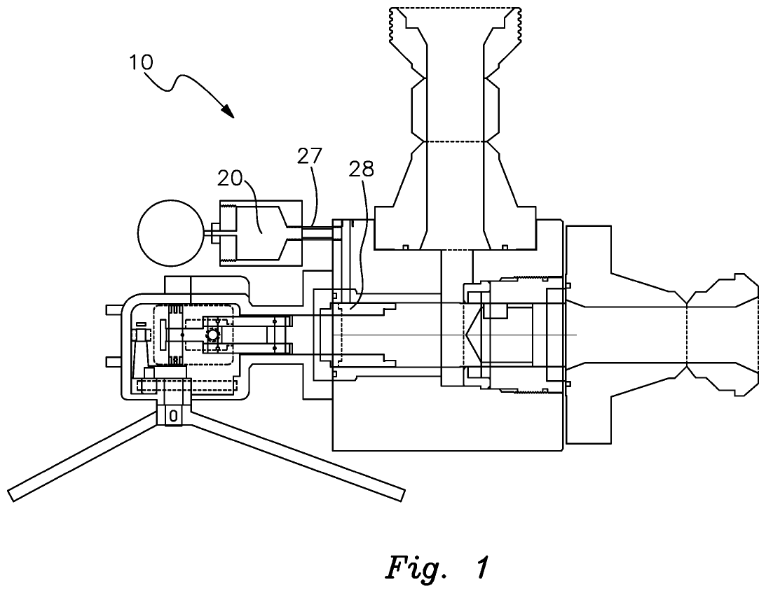

FIG. 1, shows a side cross sectional view of a relief valve according to a preferred embodiment of the invention.

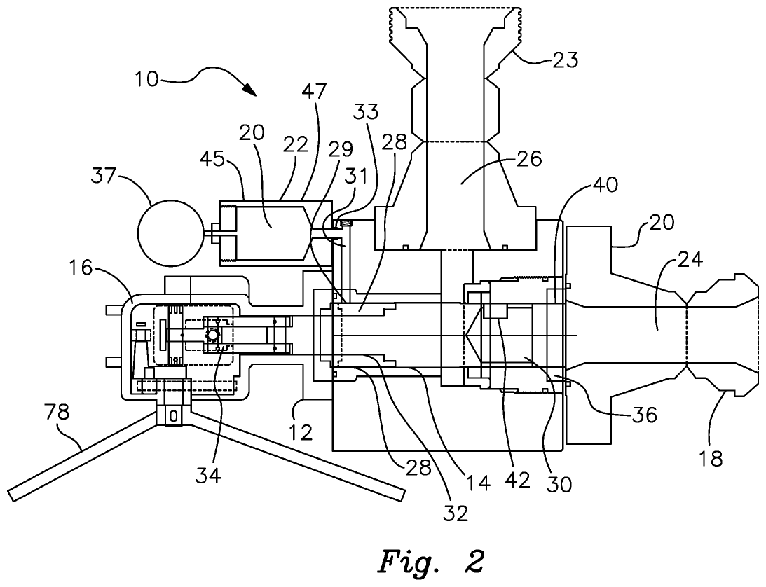

FIG. 2, shows a side cross sectional view of a relief valve according to a preferred embodiment of the invention in a closed position.

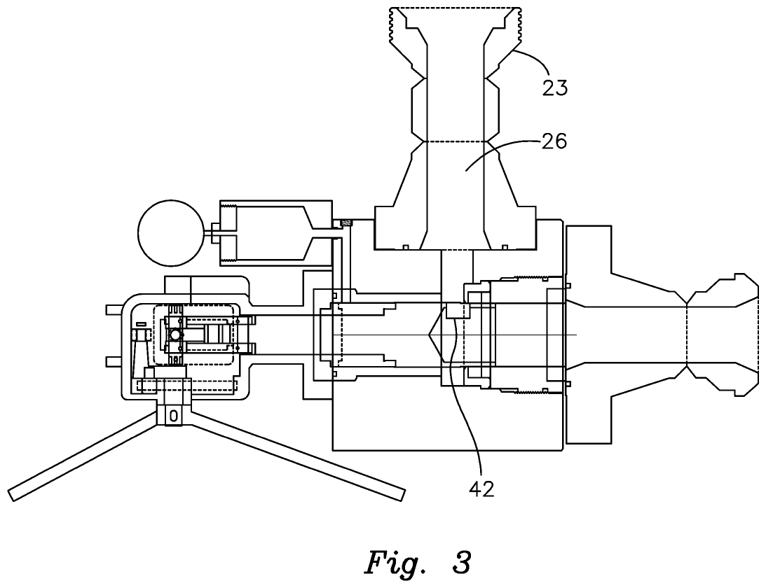

FIG. 3, shows a side cross sectional view of a relief valve according to a preferred embodiment of the invention in an open position.

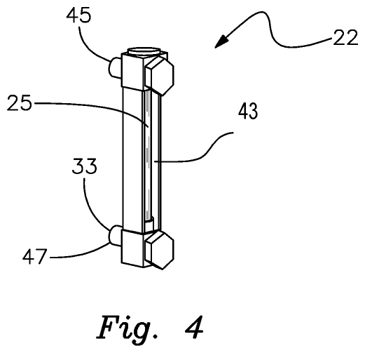

FIG. 4, shows a perspective view of a sight glass according to a preferred embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for any claim and as a representative basis for teaching one skilled in the art to employ the present invention in virtually any appropriately detailed system, structure, or manner.

Turning now to FIG. 1, there is shown a cross sectional view of the pressure relief valve 10 of the present invention in a closed or fluid blocking position. In this embodiment, reservoir 20 is mounted on long stem 27, the reservoir is in fluid communication with a chamber 28 further described below. FIG. 2, shows a cross sectional view of a reset relief valve of the present invention in a closed or fluid blocking position, and in FIG. 3 in an open or fluid permitting position.

As shown in FIGS. 1-3, a pressure relief valve 10 has a body 12, a piston 14 movably disposed within the body 12, and a bonnet assembly 16. FIGS. 1-3 are shown in a horizontal orientation relative to the typical assembled vertical field position. References herein to an upward or downward movement or upper and lower positions refer to an orientation of FIGS. 1-3 where bonnet assembly 16 is positioned above piston 14 in a vertical orientation. The pressure relief valve 10 is typically connected to a line conduit 18 in fluid communication with a fluid system containing a fluid under pressure, and a discharge conduit 23 in fluid communication with a fluid containment or storage structure, sump, drain line, or other arrangement for receiving fluid relieved from the fluid system.

The valve body 12 has an annular chamber 24 that is adapted to receive the inlet conduit 18, in fluid communication with an outlet port 26 that is adapted to receive the discharge conduit 23. The body 12 also has an internal bore providing an interior cylindrical wall surface that partially defines enclosed chamber 28, the features and function of which are disclosed below in more detail.

Piston 14 has a partially hollow head 30 and an elongated stem 32 extending outwardly from head 30. A stem bushing 34 is mounted in the bonnet assembly 16 such that the bottom surface of the bushing 34 is spaced from the piston 14 when the piston 14 is at a first, or set, position as shown in FIG. 2.

At the first position, the head 30 blocks the flow of fluid between the inlet port 24 and the outlet port 26. The head 30 has an annular upper surface 36 that defines, in part, a chamber 40 that receives pressurized fluid from the working system for which the valve is an intended relief. When piston 14 is at its first, or set position, the upper surface 36 is in fluid contact with the inlet conduit 18. Head 30 also has an exhaust port 42 which is shown as a rectangular cut-out portion of the piston head.

Importantly, the piston 14 has at least one port 42 through the lower portion of head 30 of the piston 14 that may provide a fluid flow path between the inlet and outlet ports. Above piston 14 there is a chamber 28 filled with oil, approximately 4 oz, that communicates through port 29 out tube 31 to reservoir 20. The key function of the tube 31 (shown in FIG. 2) is to provide a controlled flow path for hydraulic fluid to pass between chamber 28 to the reservoir 20 when the piston 14 is at its first and second positions.

Chamber 28 may be filled with any variety of fluids, including, among others, oil, anti-freeze, water, or lubrication grease. In addition, in certain applications, the chambers may be filled with other materials including gases or air. The chamber is sealed off from the working fluid by the arrangement of the piston head, and piston chamber. This controlled hydraulic fluid path between chambers 28 and reservoir 20 cushion the compressive force of the piston 14 when it is moved from its above-described first position to a second, or relief, position at which the head 30 is moved from its flow blocking position between the inlet and outlet ports, 24 and 26.

As can be seen in FIGS. 2 and 3, when piston 14 is raised to the second position, there is essentially no impediment to fluid flow between the line conduit 18, which typically contains pressurized fluid, and the discharge conduit 23 which is typically open to atmosphere, or ambient pressure through exhaust port 42.

Situated above chamber 28 and in fluid communication therewith, is the reservoir assembly of the present invention including reservoir 20, and sight 22, inlet port 33. Reservoir 20 is designed to hold sufficient fluid so that upon activation of the valve, fluid flows from the chamber 28 into reservoir 20 and is visible through the sight glass 22.

Pressure gauge 37 is operably connected to the reservoir to show pressure spikes as the valve is set off. Once the valve is set off, pressure returns to ambient atmospheric pressure and the level of oil in the system is measurable by viewing in the sight glass and indexed markings on the glass showing fluid amounts. As pressure is being monitored data points may be downloaded or stored by using an electronically connected gauge, allowing the user to monitor performance of the valve, oil levels and making sure its operation is within desired operating limits before during and after the valve is activated. Data from the monitor may be actively transmitted to a computer system via wireless transfer or other communications means well known in the art. Such data may be monitored off site for proper maintenance of the valve.

Sight glass 22 shown in FIG. 4 is integrally attached to reservoir 20 by machining a depression in the side wall of tubular reservoir 20 and affixing it to the sidewalls with upper screw 45 and lower screw 47. Lower screw 47 has a hollow center through inlet port 33 and permits fluid communication between reservoir 20 and internal chamber 25 of sight glass 22 so that the level of the oil in reservoir 20 is visible through viewer glass 43. Viewer glass 43 may be calibrated to show the fluid amount in the combined reservoir 20 and sight glass 22 and chamber 28 to properly monitor fluid levels and allow an operator to add oil as needed through a separate port on the reservoir or on the relief valve in communication with chamber 28.

In normal operation, with the line, or system pressure at a pressure less than the predetermined value at which it is desired to relieve system pressure, the piston 14 is at its first position. At this position, fluid will flow from the inlet port 24, and stop at the upper surface 36 of piston 14, until there is essentially equal pressure on piston 14 and in turn within chamber 28. Outlet port 26 is positioned so that it does not permit working fluid flow when the valve is in its first position to enter annular chamber 24. However, when the line pressure exceeds the predetermined value, typically as an almost instantaneous pressure spike resulting from line blockage, the valve 10 will trip in the manner described below, rapidly raising the head 30 away from its first position. Initially, the piston 14 will raise very rapidly, thereby decreasing the volume of the enclosed chamber 28, and in turn forcing fluid out flow path tube 31 into reservoir 20. As the head 30 continues to move upwardly toward the stem bushing 34, the volume of the enclosed chamber 28 decreases and, since the hydraulic fluid oil of this example is essentially a noncompressible fluid, the rate of upward movement of the piston 14 is restricted by the rate at which hydraulic fluid can be moved from the enclosed chamber 28, through the port 29, out tube 31 and into reservoir 20. Thus, the impact of the head 30 against the stem bushing 34, at the upward limit of travel of the head 30 is cushioned, and no rebound forces are imposed on the head 30 that would cause it to move toward the closed position. The size and shape of tube 31 may be of any of a variety of configurations including an ellipse, oval, square or other opening shape.

Depending upon the viscosity of the hydraulic fluid placed in chamber 28, both the number and diameter of the flow path 31 may vary and can be readily determined by one of ordinary skill in the art of fluid mechanics. In the above-described illustrative application in which oil is the hydraulic fluid, tube 31, having a diameter of about 0.1875 in (0.476 cm), permit movement of oil into the reservoir.

The pressure relief valve 10 embodying the present invention also has a first means for urging the piston into the above-described first position illustrated in FIGS. 1-3. The first means includes a pair of load springs that are controllably compressed between upper and lower spring retainers. The upper retainer is adjustably mounted on the bonnet assembly 16 by an adjustable nut threadably secured to an adjusting stud. With reference to FIG. 3, the lower end of a load screw is secured to the lower retainer and has an enlarged head at its upper end that fits into a mating socket provided at one end of a pivot crank member and, as a result of the downward force applied by the compression springs on the lower spring retainer, urges the socket end of the pivot crank in a downward direction. The pivot crank member is pivotally mounted on a crank pivot pin. The second end of the crank member biasedly engages the outer ends of two spiral springs (not shown) that are concentrically mounted on a top crank pin (not shown) that is rotatably mounted in the second end of the pivot crank. The inner ends of the two spiral springs are secured to the top crank pin, such that a small bias force acting in a counterclockwise direction is applied to the top crank pin. The upper end of an upper link is attached to the top crank pin and accordingly moves in concert with the pin about its axis. The lower end of the upper link is pivotally interconnected with the upper end of a lower link by an upper link pin. The lower end of the lower link is pivotally attached to an upper end of the piston stem by a lower link pin. Lower link is also positioned on the other side of the pin so that along its entire length is a uniform width which can be pressed against the crank. Lower link is flattened and its planar surface has the shape of an oval with two opposing parallel sides and two opposing substantially rounded ends. This construction provides added strength to the linkage and permits proper engagement with the crank as more fully described below.

When the valve 10 is in its operatively set position, with the head 30 at the first, or flow-blocking position, the upper and lower links are vertically aligned thereby forming an essentially rigid line such that the compression force of the springs is transferred through the load screw to the pivot crank, thence through the top crank pin to the aligned upper and lower links and then to the upper end of the piston stem. If the pressure against the upper surface 36 of the piston 14 increases to a value greater than the compressive force applied to the upper end of the piston stem by the load springs, the second end of the pivot crank will be forced to rotate in a clockwise direction, causing the upper end of the upper link to be moved out of alignment with the lower link pin. At this instant, the upper link pin will immediately move leftwardly, causing the upper and lower links to be moved out of vertical alignment, and thereby allowing the piston 14 to move upwardly. When the links are moved out of alignment, the upward movement of the piston 14 is, as described above, impeded only by the flow of fluid from the enclosed chamber 28 through tube 31 to reservoir 20. Reset stem may be used to facilitate manually moving the valve into an open position when not under pressure or tripping the valve when under pressure. As can be readily seen in FIG. 3, line or working fluid is quickly expelled through outlet port 26 facilitating the rapid flow of line fluid to the discharge conduit 23.

Because the upward movement of the piston 14 is cushioned, there are no rebound, or “bounce” forces imposed on the piston 14, and accordingly the piston will not undesirably reset itself. The valve 10 embodying the present invention provides a second means for resetting the valve, i.e., for engaging the first means for urging the piston 14 into the first position. The second means includes a reset crank (not shown) that is rotatably mounted in the bonnet assembly 16, and has a handle 78 at one end extending externally of the bonnet assembly 16 and a roller at a second end disposed within the bonnet assembly 16. The reset crank is biased by a reset lower spring whereby the roller at the second end of reset crank is maintained in a spaced, or clearance, position from the upper link, even when the upper link is displaced from vertical alignment with the lower link, i.e., when the piston 14 is at the second position.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims and the later issued claims.

1. A reset relief valve with dampening reservoir comprising:
a body having an inlet port, an outlet port, and an interior wall partially defining an enclosed chamber;
a piston disposed in the body and moveable between a first position at which the piston is disposed in fluid flow-blocking relationship between the inlet port and the outlet port of the body and a second position at which the piston is removed from the fluid flow-blocking position;
the piston having a head which partially defines an enclosed first chamber and at least one flow passageway extending between the chamber in the body and a reservoir chamber mounted on the body for controlled flow of hydraulic fluid to dampen the movement of the piston upon activation;
a bonnet attached to the body; and
a stem bushing disposed in the bonnet in spaced relationship with the head of the piston, the stem bushing having a surface defining another portion of the first chamber and an internal bore in which the stem is slidably supported.

2. The reset relief valve with dampening reservoir as claimed in claim 1 wherein the reservoir has a pressure monitor in fluid communication with the reservoir.

3. The reset relief valve with dampening reservoir as claimed in claim 1 further comprising a sight glass mounted on the reservoir.

4. The reset relief valve with dampening reservoir as claimed in claim 1 wherein the fluid communication channel is a tubular void.

5. The reset relief valve with dampening reservoir as claimed in claim 1 further comprising a pressure monitor mounted on the reservoir.

6. The reset relief valve with dampening reservoir as claimed in claim 1 further comprising oil in the reservoir.

7. The reset relief valve with dampening reservoir as claimed in claim 1 further comprising a sight glass in fluid communication with the reservoir.

8. The reset relief valve with dampening reservoir as claimed in claim 5 wherein the pressure monitor is an electronically connected gauge for downloading of data associated with the operation of the valve.

9. A reset relief valve with dampening reservoir comprising:
a body having an inlet port, an outlet port, and an interior wall partially defining an enclosed chamber;
a piston disposed in the body and moveable between a first position at which the piston is disposed in fluid flow-blocking relationship between the inlet port and the outlet port of the body and a second position at which the piston is removed from the fluid flow-blocking position;
the piston having a head which partially defines an enclosed first chamber and at least one flow passageway extending between the chamber in the body and a reservoir chamber mounted on the body in fluid communication with the first chamber;
a bonnet attached to the body; and
a stem bushing disposed in the bonnet in spaced relationship with the head of the piston, the stem bushing having a surface defining another portion of the first chamber and an internal bore in which the stem is slidably supported.

10. The reset relief valve with dampening reservoir as claimed in claim 9 wherein the reservoir has a pressure monitor in fluid communication with the reservoir.

11. The reset relief valve with dampening reservoir as claimed in claim 9 further comprising a sight glass mounted on the reservoir.

12. The reset relief valve with dampening reservoir as claimed in claim 9 wherein the fluid communication channel is a tubular void.

13. The reset relief valve with dampening reservoir as claimed in claim 9 further comprising hydraulic fluid in the reservoir to dampen the movement of the piston upon activation.

14. A reset relief valve with dampening reservoir comprising:
a body having an inlet port, an outlet port, and an interior wall partially defining an enclosed chamber;
a piston disposed in the body and moveable between a first position at which the piston is disposed in fluid flow-blocking relationship between the inlet port and the outlet port of the body and a second position at which the piston is removed from the fluid flow-blocking position;
the piston having a head which partially defines an enclosed first chamber and a tubular passageway extending between the chamber in the body and a reservoir body having a chamber mounted in fluid communication with the first chamber;
a bonnet attached to the body; and
a stem bushing disposed in the bonnet in spaced relationship with the head of the piston, the stem bushing having a surface defining another portion of the first chamber and an internal bore in which the stem is slidably supported.

15. The reset relief valve with dampening reservoir as claimed in claim 14 wherein the reservoir has a pressure gauge operably engaged to sense pressure in the reservoir.

16. The reset relief valve with dampening reservoir as claimed in claim 14 further comprising a sight chamber in fluid communication with the reservoir.

17. The reset relief valve with dampening reservoir as claimed in claim 14 wherein the sight chamber has a clear window showing the level of fluid in the reservoir.

18. The reset relief valve with dampening reservoir as claimed in claim 16 further comprising markings on the sight chamber to show the amount of hydraulic fluid in the reservoir.

19. The reset relief valve with dampening reservoir as claimed in claim 16 wherein the sight chamber is mounted flush in a depression in the reservoir.
